(19) United States
(12) Patent Application Publication
(10) Pub. No.: US 2014/0215393 A1
(43) Pub. Date: Jul. 31, 2014

(54) TOUCH-BASED MULTIPLE SELECTION

(71) Applicant: INTERNATIONAL BUSINESS MACHINES CORPORATION, Armonk, NY (US)

(72) Inventors: David R. Schwartz, Bellevue, WA (US); James L. Lentz, Austin, TX (US)

(73) Assignee: INTERNATIONAL BUSINESS MACHINES CORPORATION, Armonk, NY (US)

(21) Appl. No.: 13/755,208

(22) Filed: Jan. 31, 2013

(51) Int. Cl. G06F 3/0482

(52) U.S. Cl. CPC G06F 3/0482
USPC 715/810

(57) ABSTRACT

Some embodiments of the inventive subject matter may include a method for selecting objects on a computing device having a touchscreen. The method can include initiating a marquee-selection mode on the computing device, wherein the initiating occurs in response to placing one or more fingers on the touchscreen. The method can include presenting a selection marquee on the touchscreen. The method can include detecting user input defining the selection marquee, wherein the selection marquee indicates at least one object for selection. The method can include determining the objects that are selected, as indicated by the selection marquee.

### BACKGROUND

Embodiments of the inventive subject matter generally relate to the field of computing devices and more particularly to multi-touch gestures on computing devices having touchscreens.

Today, many computing devices (e.g. computers, mobile phones, tablets, mp3 players, etc.) incorporate touchscreens through which a user can provide touch input. Many computing devices with touchscreens employ soft buttons which users select to perform operations on the computing device. For example, a mobile phone may have a soft button which when selected, will initiate a telephone call. More advanced computing devices are capable of processing multi-touch input (i.e. input that comprises distinct simultaneous touches on the touchscreen from more than one finger).

Many computing devices can receive complex input in the form of gestures. Such gestures may include sliding one or more fingers across the touchscreen, changing the relative position of one or more fingers with respect to another finger on the touchscreen, etc. For example, a common multi-touch gesture is the “pinch-to-zoom” gesture which allows a user to enlarge the image displayed on the touchscreen by placing two fingers on the touchscreen and then sliding the two fingers apart while remaining in contact with the touchscreen.

Multi-touch gestures can provide an easy way for a user to accomplish complex tasks on a computing device. Computing devices however lack an easy and intuitive way to select objects on the touchscreen (e.g., selecting a portion of text or a group of images presented on the touchscreen). For example, many selection methods may require several touches that are distinct in time. These selection techniques can be cumbersome and time consuming.

### SUMMARY

Some embodiments of the inventive subject matter may include a method for selecting objects on a computing device having a touchscreen. The method can include initiating a marquee-selection mode on the computing device, wherein the initiating occurs in response to placing one or more fingers on the touchscreen. The method can include presenting a selection marquee on the touchscreen. The method can include detecting user input defining the selection marquee, wherein the selection marquee indicates at least one object for selection. The method can include determining the objects that are selected, as indicated by the selection marquee.

### BRIEF DESCRIPTION OF THE DRAWINGS

The present embodiments may be better understood, and numerous objects, features, and advantages made apparent to those skilled in the art by referencing the accompanying drawings.

FIG. 1 is a conceptual drawing depicting manipulation of a selection marquee 108 on a computing device 102.

FIG. 2 is a flow diagram illustrating operations for marquee selection on a computing device.

FIG. 3a is a conceptual drawing depicting a marquee selection mode.

FIG. 3b is a conceptual drawing depicting shaping of the selection marquee 324 using the left pull-bar 338.

FIG. 4a is a conceptual drawing depicting manipulation of a selection marquee 412 on a touchscreen 402 using four fingers to create a selection marquee 412 in the shape of a quadrilateral.

FIG. 4b is a conceptual drawing depicting increasing the size of the selection marquee 428.

FIG. 5 is a conceptual diagram depicting manipulation of a selection marquee 510 on a computing device 502 using three fingers to create the selection marquee 510 in the shape of a triangle.

FIG. 6 is a conceptual diagram depicting manipulation of the selection marquee 610 to comprise non-linear boundaries.

FIG. 7 is a block diagram of a computing device 700 upon which a multi-touch marquee selection method may be used.

### DESCRIPTION OF EMBODIMENT(S)

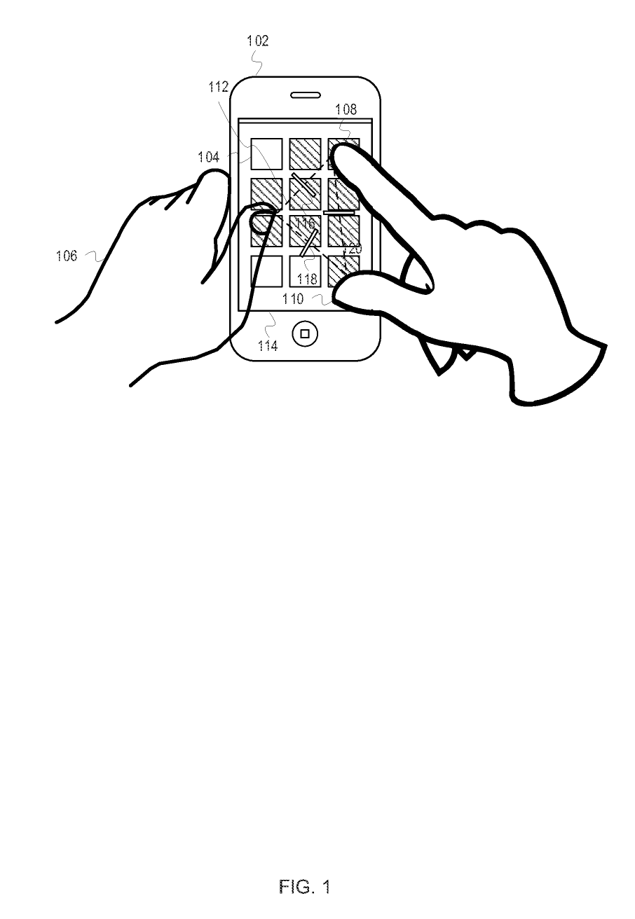

Some embodiments of the inventive subject matter include a method with which a user can select some of the objects presented on a computing device's touchscreen using multi-touch gestures. In one embodiment, a user may initiate a multi-touch mode by placing one or more fingers on the computing device's touchscreen. Initiation of the multi-touch mode may cause the computing device to present a selection marquee with which the user can select objects on the touchscreen. In some instances, the user may place yet another finger on the touchscreen to further define boundaries of the selection marquee. FIG. 1 shows how some embodiments work.

FIG. 1 is a conceptual drawing depicting manipulation of a selection marquee 108 on a computing device 102. The user is holding the computing device 102 in their left hand 106. The user is making contact with the computing device's 102 touchscreen at three points—the user's thumb on left hand 106, and index finger 108 and thumb 110 on the user's right hand. The boundaries of the selection marquee 112 are defined by these three contact points. The selection marquee 112 intersects several objects 104 on the touchscreen 114. The objects 104 that are intersected by the selection marquee 112 (indicated by hashing) are selected by the user, as shown in FIG. 1. Additionally, in some embodiments, the selection marquee 112 may include pull-bars 116, 118, and 120. The user may be able to manipulate the shape of the selection marquee 112 using the pull-bar 116 (or any other pull-bar). For example, the user may be able to touch and drag the pull-bar 116 to create a selection marquee in the shape of a quadrilateral. The resulting quadrilateral selection marquee may have boundaries on the left indicated by contact points 108 and 110 and on the right by the initial contact point 106 and the final location of the pull-bar 116. In some embodiments, the user may not be holding the computing device in their hand. Additionally, the user can contact the computing device's touchscreen with any fingers.

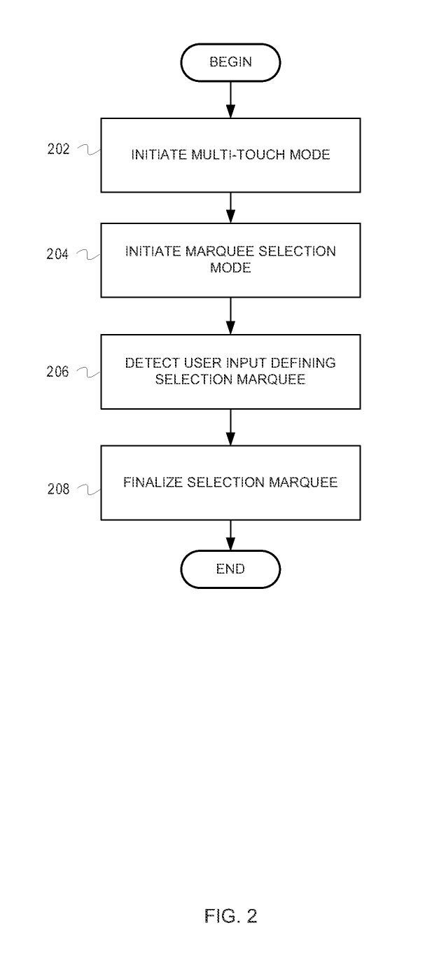

While FIG. 1 provides an overview of one embodiment of the inventive subject matter, FIG. 2 provides illustrative operations for practicing some embodiments of the inventive subject matter.

FIG. 2 is a flow diagram illustrating operations for marquee selection on a computing device. The flow begins at block 202.

At block 202, the computing device initiates a multi-touch mode. In some embodiments, the multi-touch mode is initiated when a user places one or more fingers on the computing device's touchscreen. For example, the computing device may initiate the multi-touch mode when the user places two fingers on the touchscreen. In the multi-touch mode, several multi-touch gestures can be utilized. For example, a user may utilize the pinch-to-zoom gesture. Additionally, in some embodiments, when the multi-touch mode is initiated, the computing device can present a selection marquee to facilitate selection of objects on the touchscreen. The selection marquee may initially be presented as an empty selection marquee (i.e. a dotted line). The selection marquee can include “pull bars” that allow the user to reshape the selection marquee. The flow continues at block 204.

At block 204, the computing device enters a marquee-selection mode. In some embodiments, the computing device enters marquee selection mode in response to a user touching and dragging one of the pull-bars. Alternatively, the computing device may initiate the marquee-selection mode when the user places a third finger on the touchscreen while the computing device is in a multi-touch mode. Alternatively, the computing device may initiate the marquee-selection mode without further user input. That is, the computing device's environmental factors may dictate the initiation of the marquee-selection mode. For example, while a certain application is running on the computing device, placing one or more fingers on the touchscreen may cause the computing device by default to initiate the marquee-selection mode. In some embodiments, the computing device may enter the marquee selection mode when only one finger is placed on the touchscreen. The flow continues at block 206.

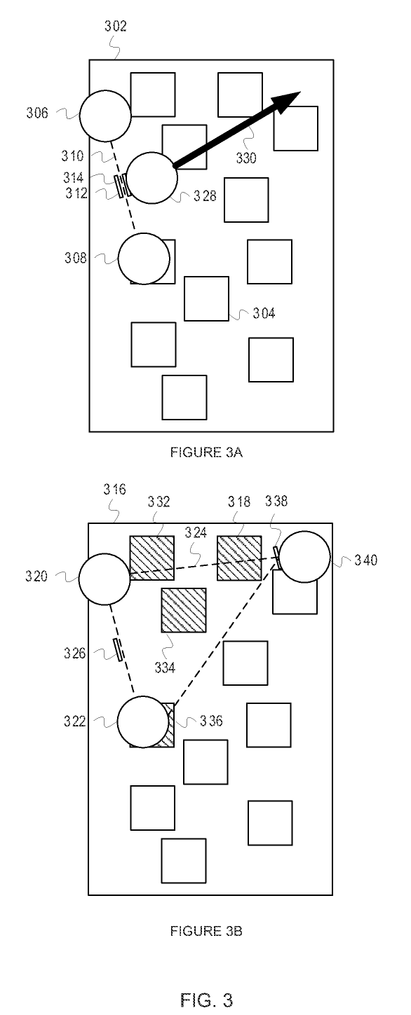

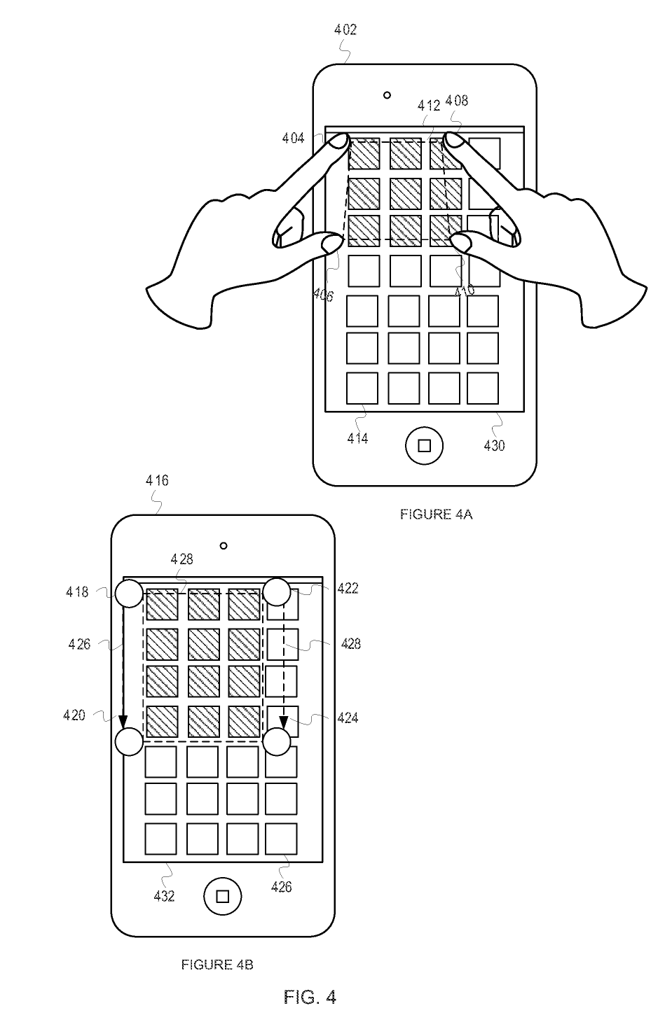

At block 206, the computing device detects user input defining the selection marquee. In some embodiments, the user may define boundaries of the selection marquee using one or more of the pull-bars (as depicted in FIG. 3 and further described below). For example, the user may touch and drag one of the pull-bars, forming a selection marquee that intersects and/or encompasses objects to select on the touchscreen. In some embodiments, the user may place a third (or fourth, etc.) finger on the touchscreen. The selection marquee would then be defined by lines linking the fingers on the touchscreen (as depicted in FIGS. 4-6). In other words, the fingers contacting the touchscreen may define the vertices of the selection marquee. Additionally, the selection marquee may be dynamic. That is, the selection marquee may be manipulated after it is created by placing additional fingers on the touchscreen or by dragging one or more of the fingers defining the selection marquee about the touchscreen. The discussion of FIGS. 3-6 (below) will describe how some embodiments enable users to define the selection marquee's shape. The flow continues at block 208.

At block 208, the computing device finalizes the selection marquee. In some embodiments, the selection marquee is finalized when the user removes one or more fingers off the touchscreen. In other embodiments, the selection marquee may be finalized when the user selects a button indicating a desire to finalize the selection marquee.

As mentioned above, embodiments allow users to define selection marquees in different ways. The discussion of FIGS. 3-6 explains how some embodiments allow users to define selection marquees to select objects on a touchscreen.

FIG. 3a is a conceptual drawing depicting a marquee selection mode. In FIG. 3a, a touchscreen 302 includes a dotted line 310, right pull-bar 312, and left pull-bar 314. The dotted line 310 is a selection marquee in compact form—i.e., before a user expands and redefines its shape. In FIG. 3a, multiple objects 304 appear on the touchscreen 302. In some embodiments, objects 304 may include graphics, text, etc. In FIG. 3a. the user has placed three fingers on the touchscreen 302, as indicated by contact points (circles) 306, 308, and 328. As shown, the computing device presents the dotted line 310, right pull-bar 312, and left pull-bar 314 between contact points 306 and 308. The user manipulates the selection marquee by touching the left pull-bar 314 at contact point 328 and dragging the left pull-bar 314, as indicated by arrow 330.

While FIG. 3a depicts the marquee selection mode prior to the completion of user input to shape the selection marquee, FIG. 3b depicts the resulting selection marquee after the user input.

FIG. 3b is a conceptual drawing depicting shaping of the selection marquee 324 using the left pull-bar 338. In FIG. 3b, the user has manipulated the selection marquee 324 by dragging right pull-bar 338 in a rightward manner across the touchscreen 316. The resulting selection marquee 324 is bounded by lines connecting contact points 320, 322, and 340. As depicted, four objects 318, 332, 334, and 336 are intersected by the selection marquee 324. Consequently, these four objects have been selected, as indicated by the hashing on objects 318, 332, 334, and 336. In some embodiments, objects will only be selected if they are fully encompassed by the selection marquee, while in other embodiments, objects may also be selected if they are intersected by the selection marquee.

FIG. 4a is a conceptual drawing depicting manipulation of a selection marquee 412 on a touchscreen 402 using four fingers to create a selection marquee 412 in the shape of a quadrilateral. In FIG. 4a, a user has placed four fingers 404, 406, 408, and 410 on the touchscreen 430. In response to detecting the four fingers on the touchscreen 402, the computing device presents the selection marquee 412 initially shaped as a quadrilateral. The topmost nine objects 414 are intersected or encompassed by the selection marquee 412. Consequently, the topmost nine objects 414 are selected, as indicated by the hashing of each of the topmost nine objects 414.

While FIG. 4a depicts an initial selection marquee, FIG. 4b shows how a user can modify an initial selection marquee by moving fingers on the touchscreen.

FIG. 4b is a conceptual drawing depicting increasing the size of the selection marquee 428. In FIG. 4b, the user has placed four fingers on the touchscreen 432 and maintained contact with the touchscreen 432 at four points 418, 420, 422, and 424. The user has slid the fingers at contact points 420 and 424 downward across the touchscreen 432. This action manipulates selection marquee 428 to intersect or encompass all objects 426 presented on the touchscreen 432. Now, all objects 426 are selected, as indicated by the hashing of each object 426. Additionally, the user can decrease the selection marquee by sliding the fingers together to intersect or encompass fewer objects. The shape of the selection marquee can also be manipulated by moving one or more fingers relative to the others. For example, the user might slide their finger at contact point 422 leftward toward contact point 418. This may have the effect of changing the shape of the selection marquee to encompass all but the topmost right object 426. In some embodiments, the size of the selection marquee can be modified using more or less than four fingers. For example, the size of a triangular selection marquee can be manipulated by moving only one finger with respect to the other two fingers.

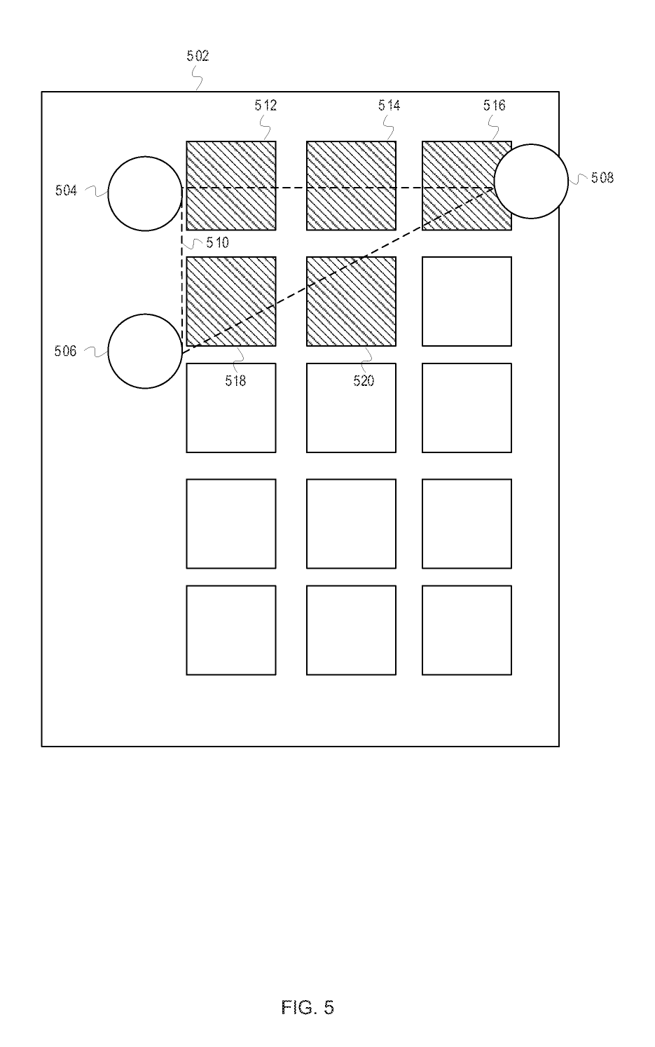

FIG. 5 is a conceptual diagram depicting manipulation of a selection marquee 510 on a computing device 502 using three fingers to create the selection marquee 510 in the shape of a triangle. As depicted in FIG. 5, the user has contacted the touchscreen 502 at three contact points 504, 506, and 508. The selection marquee 510 is initially defined by lines connecting the three contact points 504, 506, and 508. Objects 512, 514, 516, 518, and 520 are intersected or encompassed by the selection marquee 510. Consequently objects 512, 514, 516, 518, and 520 are selected, as indicated by the hashing of each object 512, 514, 516, 518, and 520.

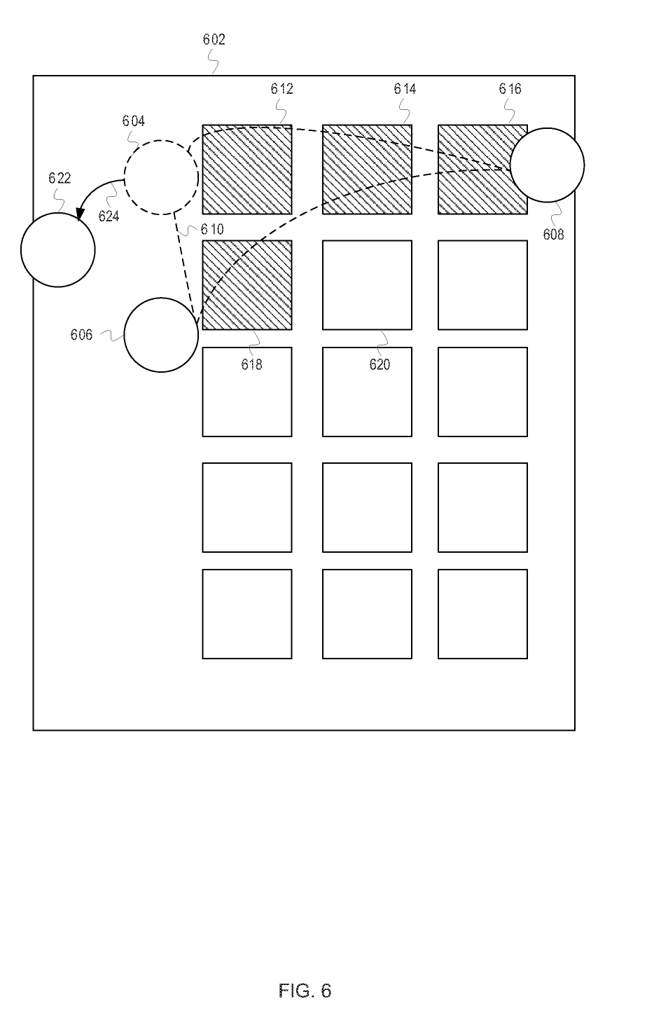

While FIG. 5 depicts an initial selection marquee, FIG. 6 depicts a resultant selection marquee after the user slides one finger in an arcing motion to curve the selection marquee.

FIG. 6 is a conceptual diagram depicting manipulation of the selection marquee 610 to comprise non-linear boundaries. Initially, the selection marquee was in the shape of a triangle (see FIG. 5), where each boundary line of the selection marquee was linear. In FIG. 6, the user has manipulated the selection marquee 610 by sliding the finger at contact point 604 to contact point 622, as indicated by arrow 624. Such manipulation results in a selection marquee 610 having non-linear boundaries. Consequently, objects 612, 614, 616, and 618 are intersected or encompassed by selection marquee 610. Objects 612, 614, 616, and 618 are selected as indicated by the hashing on each object 612, 614, 616, and 618. Because of the manipulation, object 620 is not intersected or encompassed by selection marquee 610. Consequently object 620 is not selected. Although FIG. 6 depicts finger movement in an arc-like pattern, in some embodiments, the finger movement may not necessarily be in the form of an arc. Rather, a predefined finger movement may create a curved selection marquee. For example, rotation of one or more fingers may create a curved selection marque. Referring to FIG. 6, rotation of the user's finger at contact point 604 may result in a selection marquee 610 having non-linear boundaries.

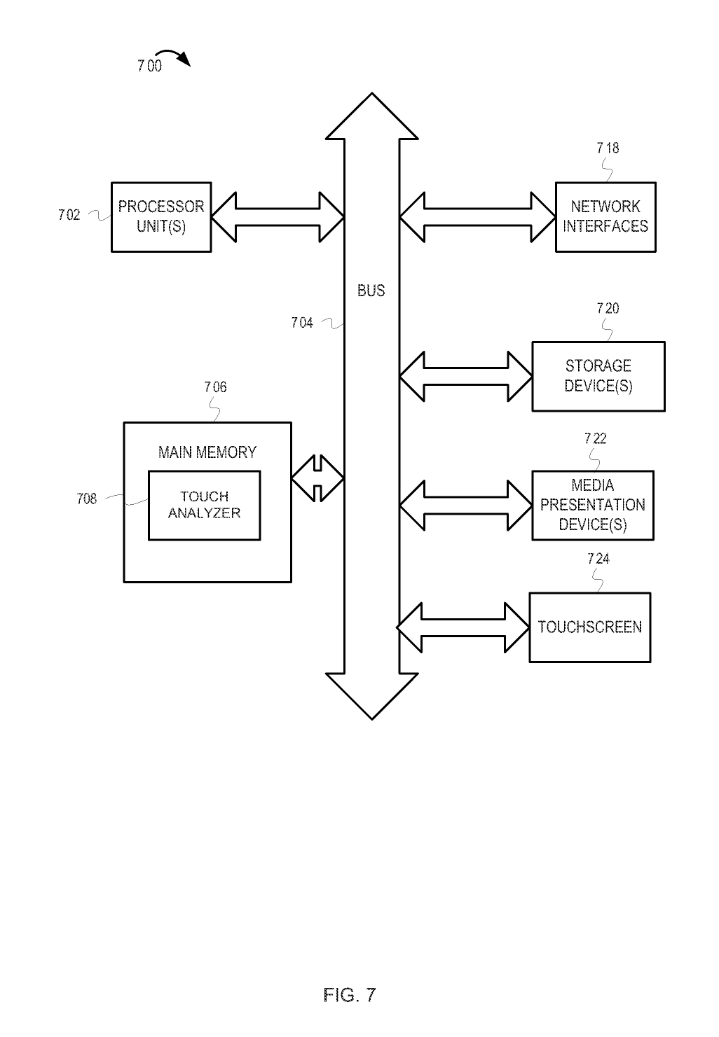

FIG. 7 is a block diagram of a computing device 700 upon which a multi-touch marquee selection method may be used. The computing device 700 includes a processor unit 702 (possibly including multiple processors, multiple cores, multiple nodes, and/or implementing multi-threading, etc.). The computing device 700 includes memory 706. The memory 706 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic computing device 700 also includes a bus 704 (e.g., PCI, ISA, PCI-Express, HyperTransport®, InfiniBand®, NuBus, etc.), a network interface 718 (e.g., an ATM interface, an Ethernet interface, a Frame Relay interface, SONET interface, wireless interface, etc.), and a storage device(s) 720 (e.g., optical storage, magnetic storage, etc.). The system memory 706 embodies functionality to implement embodiments described above. The system memory 706 may include a touch analyzer 708. In some embodiments, the touch analyzer 708 receives touch input from the user. The touch analyzer 708 may also cause the computing device to initiate a marquee selection mode (as discussed in FIG. 2). In some embodiments, the touch analyzer 708 may be part of the operating system running on the computing device 700, part of an application program running on the computing device 700, etc. Additionally, the functionality of the touch analyzer 708 can be performed by multiple components and may be embodied in any suitable form. Any one of these functionalities may be partially (or entirely) implemented in hardware and/or on the processing unit 702. For example, the functionality may be implemented with an application specific integrated circuit, in logic implemented in the processing unit 702, in a co-processor on a peripheral device or card, etc. Further, realizations may include fewer or additional components not illustrated in FIG. 7 (e.g., video cards, audio cards, additional network interfaces, peripheral devices, etc.). The processor unit 702, the storage device(s) 720, and the network interface 718 are coupled to the bus 704. Although illustrated as being coupled to the bus 704, the memory 706 may be coupled to the processor unit 702.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the embodiments are described with reference to various implementations and exploitations, it will be understood that these embodiments are illustrative and that the scope of the inventive subject matter is not limited to them. In general, techniques for initiating and modifying a selection marquee as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for selecting objects on a computing device having a touchscreen, the method comprising:
initiating a marquee-selection mode on the computing device, wherein the initiating occurs in response to placing one or more fingers on the touchscreen;
presenting a selection marquee on the touchscreen;
detecting user input defining the selection marquee, wherein the selection marquee indicates at least one object for selection;
determining the objects that are selected, as indicated by the selection marquee.

2. The method of claim 1, wherein the selection marquee initially includes boundary indicators and pull-bars.

3. The method of claim 2, wherein the user input comprises touching and dragging at least one of the pull-bars to encompass one or more objects within the selection marquee on the touchscreen.

4. The method of claim 1, wherein the user input comprises detecting further user input sufficient to create a geometric shape comprising lines between each contact point making up the user input.

5. The method of claim 4, where the lines are not linear.

6. The method of claim 1, further comprising:
detecting additional user input which changes one or more of the shape and size of the selection marquee.

7. The method of claim 1, wherein the objects that are indicated by the selection marquee is defined as the objects that are fully encompassed by the selection marquee.

8. The method of claim 1, wherein the objects that are indicated by the selection marquee is defined as the objects that are fully encompassed by the selection marquee and the objects that are intersected by a boundary of the selection marquee.

9. A computer program product for selecting objects on a computing device having a touchscreen, the computer program product comprising:
a computer readable storage medium having computer usable program code embodied therewith, the computer usable program code comprising a computer usable program code configured to:
initiate a marquee-selection mode on the computing device, wherein the initiating occurs in response to placing one or more fingers on the touchscreen;
present a selection marquee on the touchscreen;
detect user input defining the selection marquee, wherein the selection marquee indicates at least one object for selection; and
determine the objects that are selected, as indicated by the selection marquee.

10. The computer program product of claim 9, wherein the selection marquee initially includes boundary indicators and pull-bars.

11. The computer program product of claim 10, wherein the user input comprises touching and dragging at least one of the pull-bars to encompass one or more objects within the selection marquee on the touchscreen.

12. The computer program product of claim 9, wherein the user input comprises detecting further user input sufficient to create geometric shape comprising lines between each contact point making up the user input.

13. The computer program product of claim 12, wherein the lines are not linear.

14. The computer program product of claim 9, further configured to:
detect additional user input which changes one or more of the shape and size of the selection marquee.

15. The computer program product of claim 9, wherein the objects that are indicated by the selection marquee is defined as the objects that are fully encompassed by the selection marquee.

16. The computer program product of claim 9, wherein the objects that are indicated by the selection marquee is defined as the objects that are fully encompassed by the selection marquee and the objects that are intersected by a boundary of the selection marquee.

17. An apparatus for selecting objects having a touchscreen, the apparatus comprising:
at least one processor; and
a computer readable storage medium having computer usable program code executable on the at least one processor, the computer usable program code including:
code to initiate a marquee-selection mode on the apparatus, wherein the initiating occurs in response to placing one or more fingers on the touchscreen;
code to present a selection marquee on the touchscreen;
code to detect user input defining the selection marquee, wherein the selection marquee indicates at least one object for selection; and
code to determine the objects that are selected, as indicated by the selection marquee.

18. The apparatus of claim 17, wherein the selection marquee initially includes boundary indicators and one or more pull-bars.

19. The apparatus of claim 18, wherein the user input comprises touching and dragging at least one of the pull-bars to encompass one or more objects within the selection marquee.

20. The apparatus of claim 17, wherein the objects that are indicated by the selection marquee is defined as one or more of the objects that are fully encompassed by the selection marquee and the objects that are intersected by a boundary of the selection marquee.
